(19) United States
(12) Patent Application Publication
(10) Pub. No.: US 2015/0303550 A1
(43) Pub. Date: Oct. 22, 2015

(54) COMMUNICATION DEVICE ANTENNA

(71) Applicant: KING SLIDE TECHNOLOGY CO.,LTD., Kaohsiung City (TW)

(72) Inventors: Hsin-Cheng Su, Kaohsiung City (TW); Chun-Ta Liu, Kaohsiung City (TW); Shu-Chen Lin, Kaohsiung City (TW)

(73) Assignee: KING SLIDE TECHNOLOGY CO.,LTD., Kaohsiung City (TW)

(21) Appl. No.: 14/253,870

(22) Filed: Apr. 16, 2014

(51) Int. Cl. H01Q 1/24

(52) U.S. Cl. CPC H01Q 1/243

(57) ABSTRACT

The present invention relates to a communication device antenna, including a metal housing, a first antenna and a second antenna. The metal housing has a first lateral side and a second lateral side. The first antenna includes a first metal part, a second metal part, a third metal part and a fourth metal part. The third metal part is connected between the first and second metal parts, and adjacent to the first lateral side of the metal housing. The fourth metal part is connected to the metal housing. The second antenna includes a first metal part and a second metal part. The first metal part of the second antenna is connected to the signal feed point and the second metal part of the first antenna. The second metal part of the second antenna is connected to the ground point and the fourth metal part of the first antenna.

### BACKGROUND OF THE INVENTION

1. Field of the Invention

The present invention relates to a communication device antenna, and more particularly, to a metal housing being utilized as an antenna of a communication device, for emitting and receiving radio signals of the communication device.

2. Description of the Prior Art

During product development processes of conventional communication devices, such as mobile communication products, plastic housings are mainly used by manufacturers due to cost concerns, in order to maintain basic radiation characteristics of an antenna. However, a trend of metal housing is currently brought by Apple iPhones and Macbooks. Since the metal housing has light weight, good heat dissipation, high strength, high impact resistance, good looking, anti-electromagnetic and recyclable characteristics, the metal housing is getting more and more popular. Therefore, the metal housings are mainly used in development of new generations of the mobile communication products. For example, U.S. Pat. No. 8,054,231 B2 disclosed by Ahn et al. teaches a metal case having a slot, which can be used as a slot antenna of a mobile device. But the slot may obviously ruin appearance of the metal case, and the slot needs to be arranged at a position corresponding to a specific area of the metal case. Therefore, it is important to design a proper antenna to allow electromagnetic waves to penetrate the metal case for achieving communication purposes without obviously ruining the appearance of the metal case.

### SUMMARY OF THE INVENTION

It is therefore an objective of the claimed invention to provide a communication device antenna in order to utilize a metal housing as an antenna, for emitting and receiving radio signals of a communication device.

According to an embodiment of the present invention, a communication device antenna comprises a metal housing, a first antenna, a signal feed point, a ground point and a second antenna. The metal housing has a first lateral side and a second lateral side corresponding to the first lateral side. The first antenna comprises a first metal part, a second metal part, a third metal part and a fourth metal part. The third metal part is extended and connected between the first metal part and the second metal part, and the third metal part is located adjacent to the first lateral side of the metal housing. The fourth metal part is connected to the metal housing. The second antenna comprises a first metal part, a second metal part and a third metal part. The first metal part of the second antenna is connected to the signal feed point and the second metal part of the first antenna. The second metal part of the second antenna is connected to the ground point and the fourth metal part of the first antenna. The third metal part of the second antenna is extended and connected between the first metal part and the second metal part of the second antenna. A slit is formed and located between the metal housing and the first antenna.

Preferably, the first metal part of the first antenna is a straight section, the second metal part of the first antenna is a straight section, and the first metal part of the first antenna is longer than the second metal part of the first antenna.

Preferably, the first metal part of the second antenna is located between the first metal part and the second metal part of the first antenna, and the second metal part of the second antenna is located between the first metal part and the fourth metal part of the first antenna.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is diagram showing antenna arrangement of a communication device according to an embodiment of the present invention when viewing at an angle.

FIG. 2 is diagram showing antenna arrangement of the communication device according to the embodiment of the present invention when viewing at another angle.

### DETAILED DESCRIPTION

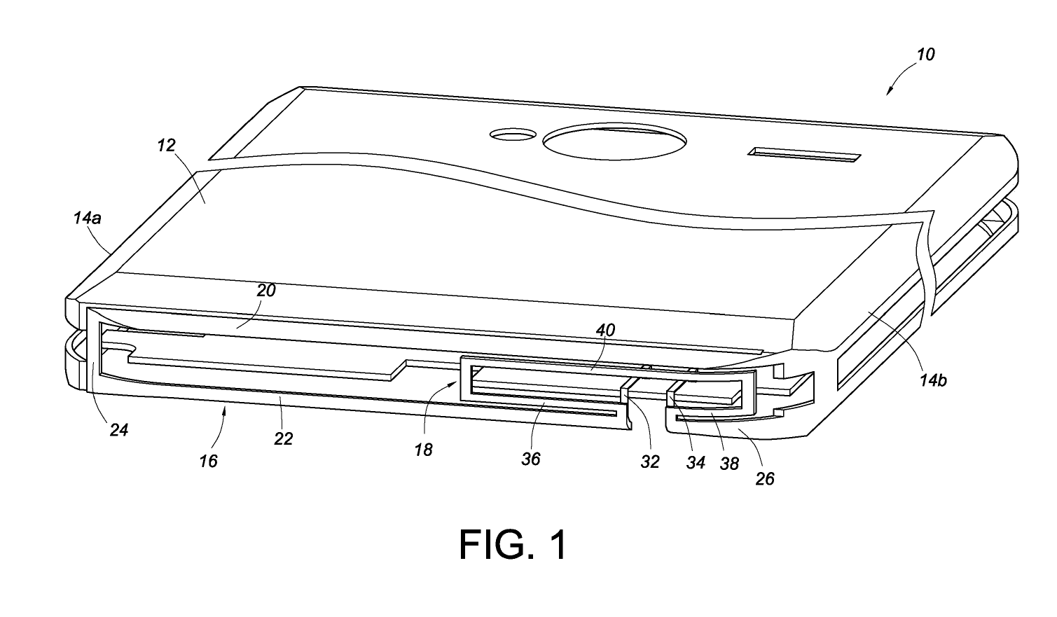

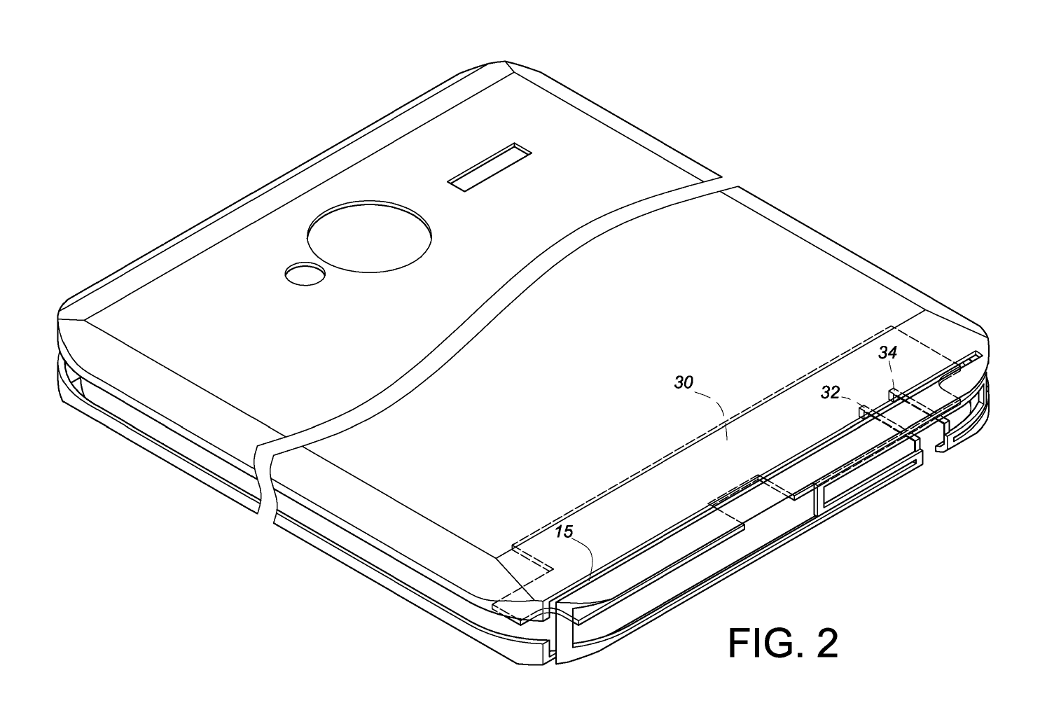

FIG. 1 and FIG. 2 are diagrams showing a communication device 10 having a metal housing 12 according to an embodiment of the present invention. The metal housing 12 has a first lateral side 14a, and a second lateral side 14b located at a position corresponding to the first lateral side 14a.

Antenna arrangement of the communication device 10 comprises a first antenna 16 and a second antenna 18. The first antenna 16 comprises a first metal part 20, a second metal part 22, a third metal part 24 and a fourth metal part 26. In a preferred embodiment, the first metal part 20 is a straight section, the second metal part 22 is also a straight section, and the first metal part 20 is longer than the second metal part 22.

The third metal part 24 is extended and connected between the first metal part 20 and the second metal part 22. In a preferred embodiment, the third metal part 24 is located adjacent to the first lateral side 14a of the metal housing 12.

In a preferred embodiment, the fourth metal part 26 is connected to the second lateral side 14b of the metal housing 12.

The first metal part 20, the second metal part 22, the third metal part 24 and the fourth metal part 26 together define an antenna trace. In addition, a slit 15 is formed and located between the metal housing 12 and the first antenna 16, such that the first antenna 16 is not short-circuited. Moreover, the slit 15 is not limited by a shape and arrangement disclosed in the embodiment of the present invention.

A printed circuit board 30 is further arranged in the communication device 10. The printed circuit board 30 comprises a signal feed point 32 and a ground point 34.

The second antenna 18 comprises a first metal part 36, a second metal part 38 and a third metal part 40 extended and connected between the first metal part 36 and the second metal part 38. Wherein the first metal part 36 is located between the first metal part 20 and the second metal part 22 of the first antenna 16, and the second metal part 38 is located between the first metal part 20 and the fourth metal part 26 of the first antenna 16. The first metal part 36 is connected to the signal feed point 32 and the second metal part 22 of the first antenna 16. The second metal part 38 is connected to the ground point 34 and the fourth metal part 26 of the first antenna 16.

According to the above arrangement, the first antenna 16 is configured to work as a larger loop antenna, which is applicable to a first frequency; and the second antenna 18 is configured to work as a smaller loop antenna, which is applicable to a second frequency. Therefore, when the communication device 10 is turned on to provide power to the first antenna 16 and the second antenna 18 via the signal feed point 32 and the ground point 34, the metal housing can work as a radiation unit, for transmitting and receiving radio signals of the communication device 10.

According to the above illustration, efficacies and advantages of the present invention are listed as follows:

a. appearance of the metal housing is not obviously ruined, and in contrast to the prior art, the metal housing has better appearance; and

b. the antenna is arranged at an edge of the metal housing, and in contrast to the prior art, the antenna occupies less space.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A communication device antenna comprising:
a metal housing having a first lateral side and a second lateral side corresponding to the first lateral side;
a first antenna comprising:
a first metal part;
a second metal part;
a third metal part extended and connected between the first metal part and the second metal part, and located adjacent to the first lateral side of the metal housing; and
a fourth metal part connected to the metal housing;
a signal feed point;
a ground point; and
a second antenna comprising:
a first metal part connected to the signal feed point and the second metal part of the first antenna;
a second metal part connected to the ground point and the fourth metal part of the first antenna; and
a third metal part extended and connected between the first metal part and the second metal part of the second antenna;
wherein a slit is formed and located between the metal housing and the first antenna.

2. The communication device antenna of claim 1, wherein the first metal part of the first antenna is a straight section, the second metal part of the first antenna is a straight section, and the first metal part of the first antenna is longer than the second metal part of the first antenna.

3. The communication device antenna of claim 1, wherein the first metal part of the second antenna is located between the first metal part and the second metal part of the first antenna, and the second metal part of the second antenna is located between the first metal part and the fourth metal part of the first antenna.
